(19) United States
(12) Patent Application Publication
(10) Pub. No.: US 2020/0391889 A1
(43) Pub. Date: Dec. 17, 2020

(54) MACHINE AND METHOD FOR PACKAGING PIECE GOOD COMBINATIONS WITH MASS BALANCING ELEMENT

(71) Applicant: KRONES AG, Neutraubling (DE)

(72) Inventors: Juergen WERNER, Bruckmuehl (DE); Johannes KIRZINGER, Unterhaching (DE); Andreas FRITSCH, Eggstaett (DE); Thomas WIMMER, Rosenheim (DE); Richard ESCHLBECK, Vogtareuth (DE); Herbert SPINDLER, Niedermoosen (DE); Manuel KOLLMUSS, Raubling (DE); Christian HASTREITER, Rosenheim (DE); Heiner SCHAEFER, Munich (DE)

(21) Appl. No.: 16/090,548

(22) PCT Filed: Dec. 29, 2016
(86) PCT No.: PCT/EP2016/082864

§ 371 Date: Oct. 1, 2018

(30) Foreign Application Priority Data
Apr. 1, 2016 (DE) 10 2016 105 984.6

(51) Int. Cl. B65B 11/00; B65B 11/58; B65B 35/44; B65B 61/04

(52) U.S. Cl. CPC B65B 11/008; B65B 11/58; F16F 15/28; B65B 61/04; B65B 35/44

(57) ABSTRACT

The invention relates to a machine for packaging piece good combinations with a transport device which transports a plurality of piece goods in a predetermined transport direction, and with a first wrapping device which is suitable and intended for wrapping the piece goods with a film element, wherein this first wrapping device has a dispensing unit revolving around the piece goods, and wherein the piece goods can be delivered to the first wrapping device in order be wrapped by the film element, According to the invention a mass balancing element likewise arranged revolving around the piece goods is associated with the dispensing unit.

The present invention relates to a machine and a method for packaging piece good combinations. It is known from the prior art that several containers, in particular plastic containers, which are filled with a beverage, can be grouped together after manufacture into piece good combinations or packs. This grouping enables in particular simpler storage and also simplified transport of the containers. In this case the packaging of such containers or the grouping into packs usually takes place by a stretchable film, also known as stretch film, with which the corresponding containers are wrapped.

In known machines for wrapping piece goods with a film, so-called stretch wrappers, the problem often occurs that no large film rolls can be used, since in particular at high rotational speeds this can lead to unbalances.

The object of the present invention therefore is to provide a machine and a method for packaging piece goods which avoids the occurrence of unbalances when large film rolls are used.

These objects are achieved according to the invention by the subject matters of the independent claims. Advantageous embodiments and further modifications form the subject matter of the subordinate claims.

A machine according to the invention for packaging piece good combinations comprises a transport device which transports a plurality of piece goods in a predetermined transport direction. Furthermore, the machine has a first wrapping device which is suitable and intended for wrapping the piece goods with a film element, wherein this first wrapping device has a dispensing unit revolving around the piece goods, and the piece goods can be delivered to the first wrapping device in order to be wrapped by the film element.

According to the invention a mass balancing element likewise arranged revolving around the piece goods is associated with the dispensing unit. In this case “revolving” is understood to mean that the mass balancing element and the dispensing unit move, preferably on a circular path, around the piece goods. The wrapping or the packaging of the containers preferably takes place continuously and around the transport direction of the piece goods, whilst the piece goods are transported by the transport device. During wrapping of the piece goods, a plurality of sheets of film lying alongside one another are produced, wherein the individual sheets overlap at their ends, so that an increased stability of the piece goods and a securely transportable packaging of the piece goods is achieved.

In this case the machine according to the invention has, in particular, the advantage that because of the mass balancing element larger dispensing units can be attached to the machine, since due to the mass balancing element a weight compensation for the roll weight of the dispensing unit is created. Moreover, due to these larger rolls or dispensing units a longer running performance of the wrapping device is achieved, since a larger amount of film can be accommodated. In addition, higher rotational speeds can also be achieved.

The aforementioned film element is preferably a stretchable film which, after the wrapping of the piece goods, is adapted to the geometry of the piece goods. The piece goods are containers and in particular plastic containers, glass bottle or cans, which are bundled into groups of containers, so-called packs.

A conveyor belt, a circulating transport chain or the like is advantageously used as the transport device. The transport of the containers or the piece goods advantageously takes place with the containers standing upright, i.e. with the mouth or the closure at the top. However, it would also be conceivable to transport the containers upside down, i.e. with the mouth region at the bottom.

Furthermore, the dispensing unit can preferably have clamping means for tensioning or for holding the film element in tension during the wrapping of the piece goods.

In a preferred embodiment the dispensing unit and the mass balancing element are arranged on a common carrier. The carrier is in particular a rotatable, annular carrier which surrounds the transport device or the piece goods in such a way that the transport direction of the piece goods or the transport device extends through the carrier, so that as the piece goods run through the annular carrier they are wrapped by a rotation of the carrier about its axis of rotation. Due to their arrangement on the common and in particular annular carrier, the mass balancing element and the dispensing unit advantageously have a common (geometric) axis of rotation.

The mass balancing element and the dispensing unit are advantageously arranged diametrically relative to one another with respect to the axis of rotation of the carrier and are arranged on the carrier in particular at an angle of 180° relative to one another. Thus a common centre of gravity can advantageously lie substantially on the axis of rotation.

Accordingly the mass balancing element serves in particular for compensation of weight changes of the film roll, so that due to these weight changes in particular no unbalances occur on the annular carrier, or the annular carrier does not run in a non-round manner. Otherwise due to these unbalances there could be a danger that the film can no longer be held in tension and as a result the piece goods are wrapped incompletely or too loosely by the film.

In a preferred embodiment it is also conceivable that the carrier is arranged rigidly and the mass balancing element and the dispensing unit are mounted movably on the carrier. In the case of a rigid carrier, the mass balancing element and the dispensing unit are also advantageously arranged on the carrier at an angle of 180° relative to one another.

In a preferred embodiment a centre of gravity of the mass balancing element and/or of the dispensing unit can be relocated, in particular as a function of an amount of film on the dispensing unit, relative to the axis of rotation of the carrier and/or relative to an axis of rotation of the revolving movement of the dispensing unit. Therefore the mass balancing element is in particular a dynamic counterweight.

Advantageously it would also be conceivable that the mass balancing element and/or the dispensing unit moves its centre of gravity as a function of the weight of the dispensing unit, so that the mass balancing element is adapted to the actual weight of the dispensing unit. The actual weight of the dispensing unit is less for every unwinding turn, so that, in this case, as the weight decreases the mass balancing element is relocated further and further in the direction of the dispensing unit.

In a further advantageous embodiment the centre of gravity of the mass balancing element and/or of the dispensing unit can be moved towards the dispensing unit or the mass balancing element respectively and/or away from the dispensing unit or the mass balancing element respectively with respect to the axis of rotation of the carrier and/or with respect to the axis of rotation of the revolving movement of the dispensing unit. The direction of movement of the mass balancing element and of the dispensing unit is advantageously always a movement in a straight line. Accordingly it is preferably proposed that, depending upon the amount of film, the centre of gravity or the centre point of the mass balancing element and/or of the dispensing unit is moved towards the centre point of the annular carrier or away from the centre point of the carrier.

A drive which enables the movement of the mass balancing element and/or of the dispensing unit is advantageously associated with the mass balancing element and/or the dispensing unit. This drive can preferably be an electrical drive or a pneumatic drive which is advantageously configured as a spindle, slide or the like and generates a vertical movement of the mass balancing element and/or of the dispensing unit. However, a fluid-based drive, for example a hydraulic system, would also be conceivable. A displacement of the centre of gravity could also take place by fluid displacement, for instance in which a fluid is pumped into a region located radially further outwards.

Furthermore, a sensor is provided which detects the amount of film on the dispensing device and, based on this, controls the movement of the mass balancing element and/or of the dispensing unit. This sensor is advantageously an optical sensor, such as for example a light barrier. Advantageously the movement of the mass balancing element and/or of the dispensing unit could also be controlled by means of for example a calculation of the rotational speed or by means of a counter which counts the number of revolutions of the dispensing unit. The sensor can advantageously also be a sensor which detects unbalances, for example a strain gauge.

The centre point of the mass balancing element and a centre point of the dispensing unit preferably lie on an axis, wherein this axis extends through the axis of rotation of the carrier. Therefore, the centre point of the mass balancing element, the centre point of the dispensing unit and the axis of rotation of the carrier lie on one axis.

In an advantageous embodiment the weight or the mass of the dispensing unit and/or of the film roll does not deviate by more than ±50% from the weight or the mass of the mass balancing element. The mass balancing element preferably has a constant weight. In a further advantageous embodiment it would also be conceivable for the weight or the mass to deviate by more than 10%, preferably by more than 20% and particularly preferably by more than 30% of the weight of the dispensing unit and/or of the film roll to be arranged thereon.

In a further advantageous embodiment the machine also has a separating element which, after the wrapping or packaging of the piece goods, severs the film element in a predetermined region, so that packs with a required number of containers, for example four, six, eight or more are produced. The separating element is advantageously arranged downstream with respect to the wrapping devices. The separating element advantageously moves together with the piece good combination or the pack, so that the film element can be severed during the transport of the piece good combination. Preferably, the separating element can therefore also be arranged rotatably. In particular a blade, a laser, shears or the like is used as the separating element.

Furthermore, it would advantageously also be conceivable for the machine to have a second wrapping device and/or a third wrapping device or a plurality of wrapping devices which are arranged successively, so that several piece good combinations can be produced simultaneously or the piece goods can be wrapped multiple times. It is also possible to provide the further wrapping devices so that for example in the event of a film change on the first wrapping device no stoppage of the machine occurs, since the wrapping of the piece goods can be continued with one of the further wrapping devices during the film change.

Before the wrapping, the containers are advantageously pushed onto a stationary carrier which is advantageously also wrapped with the film element. Furthermore, at least in the region of the wrapping device the containers are transported between two lateral guiding elements which are also wrapped like the carrier. In this case these lateral guiding elements are preferably designed as rod-like members which extend on the right and left side of the containers in the transport direction of the containers. After the wrapping the piece good combinations can be removed by these lateral guiding elements and by the carrier.

Furthermore, the present invention is directed to a wrapping device for wrapping piece goods which comprises an annular carrier on which at least one dispensing unit is arranged to revolve around the piece goods, wherein a film element for wrapping the piece goods can be arranged on the dispensing unit. In this case in particular the film element is a film roll or can be unwound from a film roll which is arranged (rotatably) on the dispensing unit.

According to the invention the wrapping device also has a mass balancing element, wherein the mass balancing element and the dispensing unit are arranged on a common carrier and the mass balancing element and/or the dispensing unit are movable relative to an axis of rotation of the carrier.

The carrier is advantageously a rotatable, annular carrier, wherein the transport device of the piece goods extends through the carrier, so that as the piece goods run through the annular carrier they are wrapped by the film element of the dispensing unit by a rotation of the carrier about its axis of rotation. Due to their arrangement on the common, in particular annular carrier, the mass balancing element and the dispensing unit advantageously also have a common axis of rotation.

The mass balancing element and the dispensing unit are advantageously arranged diametrically relative to one another with respect to the axis of rotation of the carrier and are arranged on the carrier in particular at an angle of 180° relative to one another.

In an advantageous wrapping device the mass balancing element is movable relative to the axis of rotation of the carrier as a function of an amount of film on the dispensing unit. The wrapping device is advantageously designed in the manner described above.

Furthermore, the invention is directed to a method for packaging piece good combinations, wherein a transport device transports a plurality of piece goods in a predetermined transport direction, and wherein a first wrapping device wraps the piece goods with a film element, wherein this first wrapping device has a dispensing unit revolving around the piece goods, and wherein the piece goods are delivered to the first wrapping device in order to be wrapped by the film element.

According to the invention a mass balancing element is associated with the dispensing unit and a centre of gravity of the mass balancing element and/or the dispensing unit is replaced relative to an axis of rotation. In this case it is also proposed in terms of the method that the replacement of the mass balancing element and/or of the dispensing unit takes place as a function of the amount of film on the dispensing unit. However, in this case again it would also be conceivable that the mass balancing element replaces its centre of gravity as a function of the weight of the dispensing unit, and accordingly the mass balancing element is adapted in terms of its positioning to the actual weight or the actual mass of the dispensing unit.

Accordingly, in an advantageous method the mass balancing element and/or the dispensing unit moves its centre of gravity with respect to the axis of rotation towards the dispensing unit or the mass balancing element respectively and/or away from the dispensing unit or the mass balancing element respectively.

The mass balancing element and the dispensing unit are advantageously arranged on a common carrier, wherein the carrier is advantageously a rotatable, annular carrier. The above-mentioned axis of rotation is in particular an axis of rotation of the carrier.

The mass balancing element and the dispensing unit advantageously carry out a movement in a straight line, so that the centre of gravity or the centre point of the mass balancing element and/or of the dispensing unit is moved towards the centre point or the axis of rotation of the annular carrier or correspondingly away from the centre point or the axis of rotation of the carrier.

In an advantageous method, after the wrapping of the containers the film element is severed by means of a separating element in a predetermined region, so that piece good combinations or packs with the required number of containers are produced.

Further advantages and embodiments are apparent from the appended drawings.

In the drawings:

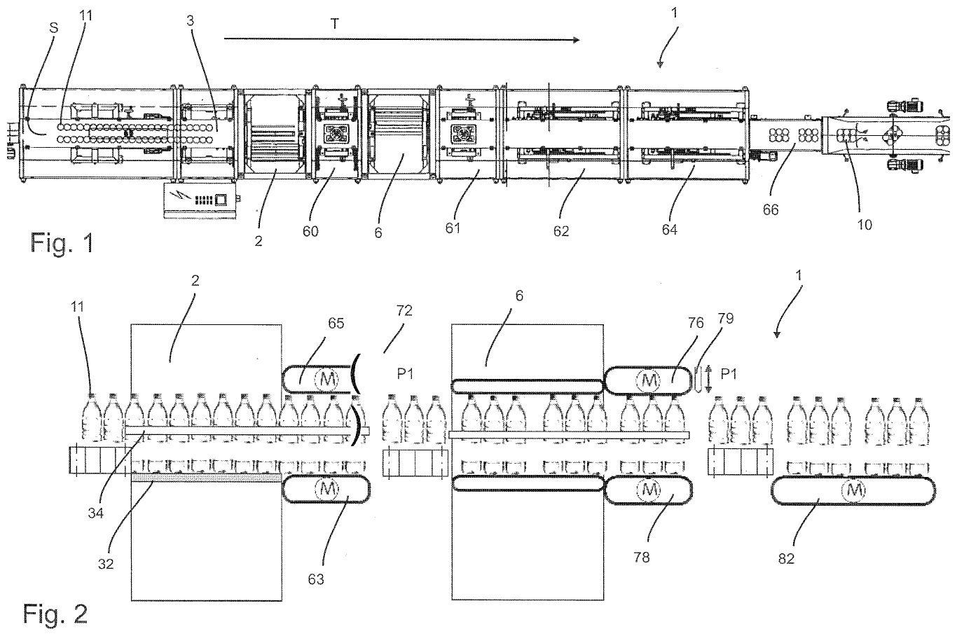

FIG. 1 shows a schematic representation of a machine for wrapping piece good combinations;

FIG. 2 shows a further representation of a machine for wrapping piece good combinations;

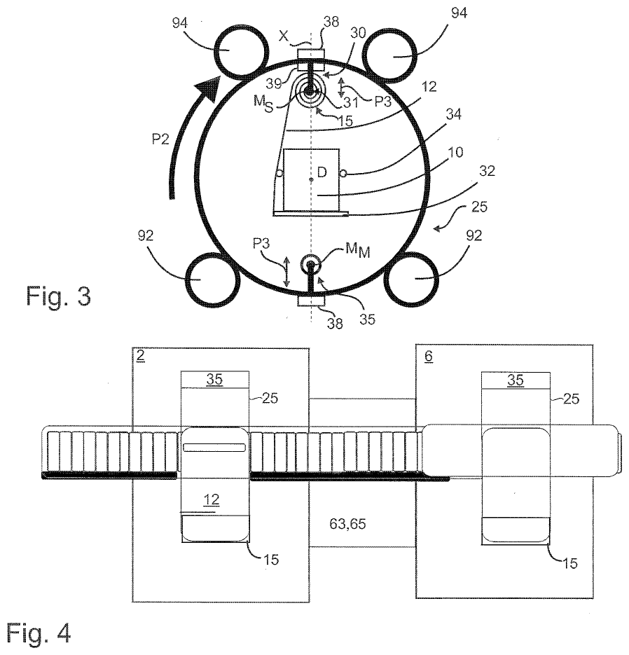

FIG. 3 shows a schematic representation of a wrapping device according to the invention; and

FIG. 4 shows a further representation of a machine for wrapping piece good combinations.

FIG. 1 shows a schematic representation of a section of a packaging machine or a machine 1 according to the patent. In this case containers 11 are delivered as single articles or as a stream of piece goods S. The reference numeral 3 designates a transport device which transports the containers or piece goods along the transport device T. In this case the transport device is preferably made up of several transport units which can also be arranged between the individual wrapping devices 2 and 6 and after them. In the machine illustrated in FIG. 1 the articles are delivered in a double-track feed by means of the first conveyor device. This delivery device can be for example a conveyor belt, a mat chain conveyor or the like.

The reference numeral 2 designates a first wrapping device which serves to wrap the containers with at least one layer of a so-called stretch film. In this case this film element is preferably wound helically in a manner which is known per se onto the articles or containers which are conveyed adjacent to one another in pairs, wherein a sufficient tension of the film element ensures the firm mechanical cohesion of the articles or stream of piece goods.

In order to ensure disruption-free transport of the stream of articles or piece goods in the first wrapping device 2, revolving feed belts (not shown) can engage for example laterally on the stream of articles or piece goods S, which convey the containers through the first wrapping device 2, whilst the containers 1 are simultaneously wrapped.

In the first wrapping device 2 the containers can for example slide on a lower slide plate (not shown) which is likewise wrapped with them.

The reference numeral 60 relates to a first feed module which is arranged downstream of the first wrapping device and serves for the further transport of the stream of articles or piece goods already wrapped with at least one layer of stretch film (typically by means of upper and lower feed belts or feed straps). In this case these feed belts or feed straps can rotate endlessly over the length of the first feed module on the upper and lower faces of the stream of articles or piece goods and thus ensure further conveying thereof to a second conveying device 6.

In the second wrapping device 6 a second layer of film element can likewise be applied helically to the stream of articles or piece goods, which preferably takes place at a different winding angle than in the first wrapping device 2 and/or in an opposing winding direction (i.e. revolving direction).

The reference numeral 61 relates to a further feed module and serves for further transport of the stream of articles or piece goods which are now wrapped with several layers of stretch film. For this purpose it is also possible in turn to use upper and lower feed belts or feed straps which preferably can rotate endlessly over the length of the second feed module 61 on the upper and lower faces of the stream of articles or piece goods and cause further conveying thereof. A multi-layer film packaging with containers 11 packaged therein, which is wrapped helically by film elements and initially moves endlessly in the conveying direction, is formed by this transport, wherein subsequently the planes perpendicular to the longitudinal axis and to the conveyor device can be provided as required with perforations, and/or packagings are severed between successive containers or pairs of containers or groups of several conveyed containers.

Accordingly the reference numerals 62 and 64 relate to cutting units or separating units which serve to separate the film elements. In this case these two cutting units 62, 64 can be redundant in order to produce higher throughput speeds.

The reference numeral 66 designates a discharge device which removes the pack 10 produced in this way.

FIG. 2 shows a side view of a corresponding machine for wrapping packs. Here again the containers 11 are illustrated as well as the slide plate or the carrier 32 onto which the plastic containers 11 are pushed. The reference numeral 34 designates lateral guiding elements which serve for lateral guiding of the containers or the piece good combinations.

The reference numerals 63 and 65 designate transport devices which in this case remove the already wrapped containers from the first wrapping device 2. The reference numeral 72 designates quite schematically a cutting or separating element which cuts the film element. This moves in a vertical direction P1.

The reference numeral 6 again designates the second wrapping device, wherein in this case likewise the already bundled containers can be wrapped again. The reference numerals 76 and 78 designate two further transport devices which in turn are intended for removing the pack from the second wrapping device 6. The reference numeral 79 designates a second cutting element which likewise serves for cutting the film element.

The reference numeral 82 designates a transport unit for removing the individual packs which are now already cut.

A wrapping device according to the invention is shown schematically in FIG. 3. This has an annular carrier, designated as a whole by 25, which is rotatable here along the arrow P2 in the corresponding direction of rotation. On this carrier a dispensing unit 30, shown quite schematically and drawn as a whole, and a mass balancing element 35 are arranged. The dispensing unit 30 has a dispensing element or a receiving device 31 on which a film roll 15 shown only schematically is, for example, rotatably arranged with a film element 12 which can be unwind therefrom. This film element 12 serves for wrapping the piece good combination 10. Here again the carrier 32 is also illustrated which is also wrapped as well as the lateral guiding elements 34. After the wrapping—as mentioned above—the piece goods combination 10 is removed again from the carrier 32 and also from the lateral guiding elements 34.

The references M_{S} and M_{M} designate the centre points of the dispensing unit and of the mass balancing element. As already described above, as the film roll 15 becomes smaller the centre of gravity of the mass balancing element 35 moves in a rectilinear movement towards the dispensing unit 30 or the centre of gravity of the dispensing unit moves in a likewise rectilinear motion towards the mass balancing element.

Furthermore, it can also be seen in FIG. 3 that the centre point M_{S} of the dispensing unit 30, the centre point M_{M} of the mass balancing element 35 and the rotational axis D of the carrier lie on a common axis X. It can also be seen from FIG. 3 that the dispensing unit 30 and the mass balancing element 35 are moved relative to the rotational axis D of the carrier 25.

The reference numerals 92 and 94 designate wheels which serve to support the revolving carrier 25. In this case one of these wheels can also be driven.

It is preferably also possible that the carrier 25 can move in two different directions of rotation. A rotational speed of the carrier 25 is advantageously synchronised with the speed of advance of the piece good combinations 10.

The reference numeral 38 designates in each case a drive for the mass balancing element 35 and the dispensing unit 30. In this representation a drive 38 is associated with both the mass balancing element 35 and also the dispensing unit 30. However, it is also conceivable that only the mass balancing element has a drive or also that only the dispensing unit has a drive. The arrow P3 designates in each case the direction of movement of the mass balancing element 35 and of the dispensing unit 30.

Furthermore, the reference numeral 39 shows schematically a sensor which is associated with the dispensing unit 30 and which for example can detect the amount of film, the revolutions of the film roll or the like.

FIG. 4 shows a schematic representation of a machine according to the invention. In this machine a first wrapping device 2 as well as a second wrapping device 6 are illustrated. In addition, however, further wrapping devices can be attached on the right-hand side. Here again the transport devices 63, 65 are illustrated between the first wrapping device and the second wrapping device. These can be in particular feed devices which remove the containers for example from the wrapping devices 2, 6. The reference numeral 15 designates a film roll. In this case the wrapping device 6 can be used for example if the film roll must be changed in the first wrapping device 2. For this purpose at least the further wrapping device 6 is suitable and intended to be operated in different revolving directions.

Furthermore, again it can also be seen that a mass balancing element 35, which moves towards the dispensing unit 30 as the film roll 15 becomes smaller, is associated with the dispensing unit 30 or the film roll 15. If several wrapping devices are provided in the machine, each wrapping device also correspondingly has a respective mass balancing element associated with the dispensing unit.

The applicant reserves the right to claim all the features disclosed in the application documents as essential to the invention in so far as they are individually or in combination novel over the prior art. Furthermore it is pointed out that in the individual drawings features were also described which may be advantageous per se. The person skilled in the art recognises immediately that a specific feature described in a drawing may also be advantageous without the incorporation of further features from this drawing. Furthermore the person skilled in the art recognises that advantages may also result from a combination of several features shown in individual drawings or in different drawings.

### LIST OF REFERENCES

1 machine
2 first wrapping device
3 transport device
6 second wrapping device
10 piece good combinations, packs
11 piece goods, containers
12 film element
15 film roll
25 carrier
30 dispensing unit
31 dispensing element, receiving device
32 slide plate, carrier
34 lateral guiding elements
35 mass balancing element
38 drive
39 sensor
60 first feed module
61 further feed module
62,64 cutting units, separating units
63,65 transport devices
66 discharge device
72 cutting element, separating element
76,78 further transport devices
79 second cutting element, second separating element
82 transport unit
92,94 wheels
D axis of rotation
S stream of piece goods
T transport direction
M_{M} centre point of the mass balancing element 35
M_{S} centre point of the dispensing unit 30
P1 vertical direction
P2 direction of rotation
P3 direction of movement
X axis

1. Machine for packaging piece good combinations with a transport device which transports a plurality of piece goods in a predetermined transport direction, and with a first wrapping device which is suitable and intended for wrapping the piece goods with a film element, wherein this first wrapping device has a dispensing unit revolving around the piece goods, and wherein the piece goods can be delivered to the first wrapping device in order be wrapped by the film element, wherein a mass balancing element likewise arranged revolving around the piece goods is associated with the dispensing unit, wherein a centre of gravity of the mass balancing element and/or of the dispensing unit can be relocated, in particular as a function of an amount of film on the dispensing unit, relative to an axis of rotation of the carrier and/or relative to an axis of rotation of the revolving movement of the dispensing unit.

2. Machine according to claim 1, wherein the dispensing unit and the mass balancing element are arranged on a common rotatable, annular carrier.

3. Machine according to claim 2, wherein the centre of gravity of the mass balancing element is movable towards the dispensing unit and/or away from the dispensing unit with respect to the axis of rotation of the carrier and/or with respect to the axis of rotation of the revolving movement of the dispensing unit.

4. Machine according to claim 2, wherein a centre point of the mass balancing element and a centre point of the dispensing unit lie on an axis and the axis extends through the axis of rotation of the carrier.

5. Machine according to claim 1, wherein the weight of the dispensing unit and/or of the film roll deviates by no more than ±50% from the weight of the mass balancing element.

6. Wrapping device for wrapping piece goods, comprising an annular carrier on which at least one dispensing unit is arranged to revolve around the piece goods, and wherein a film element for wrapping the piece goods can be arranged on the dispensing unit, characterised in that the wrapping device has a mass balancing element, wherein the mass balancing element and the dispensing unit are arranged on the common carrier and the mass balancing element is movable relative to a rotational axis of the carrier, wherein the mass balancing element and/or the dispensing unit is movable relative to the axis of rotation of the carrier as a function of an amount of film on the dispensing unit.

7. Machine for packaging piece good combinations, wherein a transport device transports a plurality of piece goods in a predetermined transport direction, and wherein a first wrapping device wraps the piece goods with a film element, wherein this first wrapping device has a dispensing unit revolving around the piece goods, and wherein the piece goods are delivered to the first wrapping device in order to be wrapped by the film element, characterised in that a mass balancing element is associated with the dispensing unit and a centre of gravity of the mass balancing element and/or the dispensing unit is relocated relative to an axis of rotation, wherein the mass balancing element moves its centre of gravity with respect to the axis of rotation towards the dispensing unit and/or away from the dispensing unit.
